(19) United States
(12) Patent Application Publication
(10) Pub. No.: US 2026/0219497 A1
(43) Pub. Date: Jul. 30, 2026

(54) HEAD-UP DISPLAY HAVING A COMBINED DISPLAY REGION

(71) Applicants: VOLKSWAGEN AKTIENGESELLSCHAFT, Wolfsburg (DE); AUDI AG, lngolstadt (DE)

(72) Inventors: Christian WALL, Hitzhofen (DE); Heiko SCHRÖDER, Meinersen (DE)

(73) Assignees: VOLKSWAGEN AKTIENGESELLSCHAFT, Wolfsburg (DE); AUDI AG, lngolstadt (DE)

(21) Appl. No.: 19/140,660

(22) PCT Filed: Dec. 18, 2023
(86) PCT No.: PCT/EP2023/086394

§ 371 Date: Jun. 18, 2025

(30) Foreign Application Priority Data
Dec. 19, 2022 (DE) 10 2022 133 881.9

(51) Int. Cl. G02B 27/01; B60K 35/231

(52) U.S. Cl. CPC G02B 27/0101; B60K 35/231; B60K 2360/23; B60K 2360/25; B60K 2360/33

(57) ABSTRACT

A head-up display for a motor vehicle may include an image-generating unit to provide a first image half and a second image half of an image. The first image half is based on a light having a first polarization and the second image half is based on a light having a second polarization. The first image half can be projected by a first optical unit onto a first partial surface, and the first optical unit is transmissive for the second image half and reflective for the first image half. The second image half can be projected by a second optical unit onto a second partial surface and the second optical unit is arranged behind the first optical unit in relation to a beam path of the first and second image halves.

### CROSS-REFERENCE TO RELATED APPLICATIONS

This application is a U.S. national stage of International Application No. PCT/EP2023/086394, filed on Dec. 18, 2023, which claims the priority benefit of German Patent Application No. 10 2022 133 881.9 filed on Dec. 19, 2022. Both the International Application and the German Patent Application are incorporated by reference herein in their entirety.

### BACKGROUND

### 1. Field

An aspect of an invention relates to a head-up display for a motor vehicle according to described examples. Furthermore, the invention according to the examples relate to a motor vehicle with a corresponding head-up display. The invention according to the examples also relates to a method for operating a head-up display.

### 2. Description of the Related Art

In modern, in particular highly automated, motor vehicles, head-up displays are used. Therein, the head-up display is for example positioned in the cockpit in front of the driver in an installation space of the passenger compartment. Thereto, the instrument panel comprises an opening in the region of the instrument cluster, which can be closed by a shield after mounting the head-up display. The available installation space for head-up displays is especially restricted in the vertical Z-axis (vehicle vertical axis).

Head-up displays and arrangements for head-up displays are for example known from WO 2019 184 335 A1, WO 2017 138 711 A1 and WO 2017 728 41 A1.

### SUMMARY

Examples objects of the present invention according to described examples are to provide a compact head-up display, by which an improved image presentation can be provided to at least one observer.

The example objects may be solved for example by a head-up display, a motor vehicle as well as a method according to the independent claims. Reasonable developments result from the dependent claims.

An aspect of the invention according to the examples relates to a head-up display for a motor vehicle that may include an image-generating unit for providing a first image half of an image and a second image half of the image, wherein the first image half of the image is based on light with a first polarization and the second image half of the image is based on light with a second polarization different from the first polarization, a first optical unit, by which the first image half of the image can be projected onto a first partial surface of a projection surface by reflection, wherein the first optical unit is formed transmissive for the second image half of the image, which is based on light with the second polarization, and reflective for the second image half of the image, which is based on light with the first polarization, and a second optical unit, by which the second image half of the image can be projected onto a second partial surface of the projection surface by reflection, wherein the second optical unit is arranged immediately behind the first optical unit in relation to a beam path of the first and the second image half of the image.

By the head-up display according to the examples, an improved image presentation or information presentation can be provided to an observer such as for example a driver and/or passenger. By dividing the presented image into a first and a second image half or a first and a second image region, the size of the presented image of the head-up display can be varied. Thus, larger images and thus more information can in particular be provided or presented to the driver and/or passenger. Hereto, the head-up display according to the examples of the invention is advantageously employed since it presents the image based on two image halves and thus requires less installation space or installation space volume than the head-up displays in the prior art. Especially, the head-up display can be arranged in the region of the instrument panel or cockpit in the vehicle or motor vehicle in space-saving manner. Furthermore, this compact construction offers the advantage for other systems, such as for example steer-by-wire, since more space is available for these further systems and/or components, since the space requirement of the head-up display could be minimized by the head-up display.

By the employment of the two optical units, by which only one image half is respectively directed towards the windscreen for presentation, installation space can be saved especially viewed in vertical z-axis of the vehicle. Thus, a volume reduction of the head-up display can be achieved. Furthermore, it is advantageous that the first and the second image half are generated by one and the same image-generating unit or imager such that a further image-generating unit is not required here. Furthermore, the proposed head-up display offers an improved presentation of a virtual image by the division into two optical paths or into two image halves.

Furthermore, the advantage arises, in particular for an employment of the head-up display, that the head-up display can also be employed if the size of the virtual image to be displayed and the virtual image distance become greater. Here, the installation space saving construction of the head-up display advantageously takes effect.

By the head-up display, which can in particular be referred to as arrangement for a head-up display, the space requirement of a head-up display can be reduced. Especially, this has the advantage that the size of a head-up display is determined and limited by the installation space in the instrument panel available in the vehicle cockpit.

The first and/or the second optical unit can be a mirror, lens, asphere, aspherical lens, freeform surface or a curved optical element. In particular, the two optical units can be configured as active optical elements. Optionally, the optical units are a freeform surface or a curved optical element.

By the first optical unit, the first image half can be projected by reflection onto the first partial surface of the projection surface. For the second image half, the first optical unit is transmissive, such that the beam path or the light beam relating to the second image half can pass through the first optical unit and thereby impinges on the second optical unit. With the aid of the second optical unit, the second image half can in turn be projected by reflection onto a second partial surface of the projection surface different from the first partial surface. The projection surface can be a translucent projection surface. The projection surface is in particular a part of a windscreen or vehicle window of the motor vehicle. Thus, the image can be presented in the field of view of the driver and/or passenger of the motor vehicle by the two image halves projected onto the partial regions.

In particular, the projection surface is a surface area of the windscreen such that the two partial halves can be partial regions of the windscreen of the motor vehicle.

In particular, the image-generating unit is formed to generate the two image halves of the image respectively with a different or distinct polarization. For example, the first image half can be based on P-polarized light and the second image half can be based on S-polarized light. Similarly, the two image halves can be based on different polarizations.

By the two different image halves, a holistic virtual image can be visually presented to the driver and/or the passenger of the motor vehicle.

In particular, the image-generating unit can be formed to simultaneously generate the first image half and the second image half. Furthermore, the optical units can be formed to simultaneously or synchronously project the two image halves onto the partial surfaces of the projection surface such that a holistic, in particular overall image, image can be presented in the field of view of the driver and/or the passenger.

The first optical unit, which is formed reflective for the first image half on the one hand, can be formed transmissive or transparent for the second image half. Thus, the first optical unit has different regions or characteristics such that the first image half can be reflected and the second image half can be transmitted or radiated through the first optical unit.

The first optical unit and/or the second optical unit can have a transflective characteristic. Thus, especially the first optical unit is formed reflective or transmissive for the different polarizations.

For example, the light with the first polarization can be light or a light beam, which can be referred to as S-polarized light. The light with the second polarization can be P-polarized light. It is also conceivable that the first polarization is in turn P-polarization and the second polarization is S-polarization. Thus, different possibilities are given, wherein the two images generated by the image-generating unit can have polarizations different from each other.

P-polarized light is TM (transverse magnetically)-polarized light. P-polarized light is present if the direction of the magnetic field is perpendicular to the plane spanned by the incidence vector and surface normal. Thus, P-polarized light can also be referred to as parallel polarized light. S-polarized light is for example TE (transverse electrically)-polarized light. One speaks of it if the electrical field is perpendicular to the plane of incidence. Thus, the S-polarized light can also be referred to as perpendicularly polarized light. Thus, the first polarization can be referred to as P-polarization and the second polarization can be referred to as S-polarization. However, they can also be inversely designated such that the first or the second polarization can be P-polarization according to case of application.

In particular, the second optical unit can be arranged immediately behind the first optical unit in relation to the beam path of the image halves. In particular, the first and the second optical unit can be arranged spaced from each other, in particular immediately one behind the other. In particular, the second optical unit is behind the first optical unit in relation to the image-generating unit, such that the second image half or the beam path of the second image half can radiate through the first optical unit and thus impinges on the second optical unit.

The beam path is the beam path from the image-generating unit to the optical units and from the optical units to the projection surface.

Thus, the image displayed on the projection surface is composed of a composition of two image halves or image parts.

In an example a first illumination unit is provided for supplying a first region of a rear side of the image-generating unit with light for providing the first image half of the image. Furthermore, the head-up display comprises a second illumination unit different from the first illumination unit for supplying a second region of the rear side of the image-generating unit different from the first region with light for providing the second image for the image. By the two different illumination units, the image-generating unit can be operated such that the first image half as well as the second image half can be generated. Thus, two different image halves can be generated by the image-generating unit, which can be displayed as a common image in the field of view of the driver and/or the passenger with the aid of the optical units. Accordingly, the head-up display can be variously used and can in particular be used or integrated in the motor vehicle optimized in installation space.

For example, the first illumination unit can be used for generating the light with the first polarization. The second illumination unit can be used for generating or providing the light with the second polarization.

The illumination units can be arranged on the rear side of the image-generating unit, which is a side opposite to an image output side or light outlet side of the image-generating unit. Thus, the illumination unit or the image-generating unit can be supplied with a respective light on the rear side, to generate or provide respectively differently polarized light. For example, the first and the second illumination unit can be referred to as backlight systems.

In an example the image-generating unit comprises a first image-generating region for providing the first image half of the image and a second image-generating region different from the first image-generating region for providing the second image half of the image on its image-generating side. Thus, the functionality for a head-up display can be provided by the image-generating unit or imager, which divides an image presented in the field of view of the observer into at least two or more image parts or image halves. Thus, the different image halves are presented on the projection surface such that a holistic impression of an image results for the observer. In particular, the image halves can be simultaneously or synchronously generated with the aid of the image-generating unit and presented in the field of view for the user or observer. Hereto, the two image-generating regions are advantageous since different or distinct image halves can be generated with one and the same image-generating unit by the two image-generating regions. In particular, the first image-generating region can be used to generate the light with the first polarization for the first image half. The second image-generating region can in turn be used for providing the second image half, which is based on light with the second polarization.

For example, the first image-generating region can be supplied with light by the first image-generating unit. The second image-generating region can in turn be supplied with light with the aid of the second image-generating unit.

In an example a retardation plate is arranged at the first image-generating region, wherein the retardation plate is formed to convert light, which is radiated from the first image-generating region, into the light with the first polarization, on which the first image half is based. Thus, the head-up display can be more compactly configured, since two different image halves based on light with the second polarization can first be provided by the image-generating unit. By the use of the retardation plate or waveplate or “half wave plate”, the light with the second polarization can be converted into the light with the first polarization.

For example, the retardation plate can be arranged externally in relation to the image-generating side at the first image-generating region. Thus, the corresponding light beam can first penetrate the first image-generating region and subsequently the retardation plate before it can be emitted or radiated outside of the image-generating unit.

For example, light or a light beam, which is P-polarized, can be first generated as the second polarization with the aid of the image-generating unit. Thus, with the aid of the retardation plate, P-polarized light can then be converted into S-polarized light. This of course also applies if S-polarized light is first provided with the aid of the image-generating unit. In this case, the retardation plate can be formed such that it converts S-polarized light into P-polarized light.

In a further example, a further retardation plate is arranged in a region between the first and the second optical unit, wherein the further retardation plate is formed to change the light, on which the second image half is based, in its polarization such that the light relating to the first image half and the light relating to the second image half have the same polarization. This is of importance since the two image halves, which together result in the overall image, have to have the same or identical polarization for a uniform and “clean” presentation of the overall image, such that the observer can perceive an image, which has a good presentation.

The further retardation plate can be a waveplate, “half wave plate” or a “quarter wave plate”. According to case of application of the head-up display and in particular according to space requirement, the further retardation plate can in particular be arranged in very different regions or positions subsequent to the first optical unit. For example, the further retardation plate can be arranged directly on the rear side of the first optical unit. If the retardation plate is a “quarter wave plate”, thus, it can be arranged directly on the front side of the second optical unit directed to the first optical unit.

In an example, the head-up display comprises an optical element, by which the first and the second image half of the image can be reflected from the image-generating unit towards the two optical units.

An optical element can be a mirror, mirror element or a deflection mirror. The optical unit can be oriented such that the first and/or the second image half can be reflected towards the optical units. Thus, a beam path can be directed from the image-generating unit via the optical element towards the two optical units. In particular, the image-generating unit and the optical element can be arranged opposing starting from the image-generating side of the image-generating unit such that the beams or light beams radiated or emitted by the image-generating unit are radiated towards the optical element such that they can be reflected on the optical element, namely towards the optical units. Since the two optical units can be arranged one behind the other or abutting one behind the other, a beam from the image-generating unit can first be reflected via the optical element to the first optical unit.

Thus, the head-up display can be used or integrated in the motor vehicle in even more installation space saving manner since the light beams do not have to be radiated directly to the optical units starting from the image-generating unit, but indirectly with the aid of the optical element. Thus, a compact construction of the head-up display can be achieved.

In an example, it is furthermore provided that the image-generating unit, the first optical unit and the second optical unit are arranged in a housing closed to an environment of the head-up display, wherein the housing comprises a housing part translucent towards of the projection surface. Thus, the components and in particular all of the components of the head-up display can be protected from damages, dust, water or other adversely affecting influences in a housing. By the housing, the head-up display can for example be positioned or arranged in the region of a dashboard or an instrument panel. The housing part of the housing or the side of the housing, which extends towards the projection surface, thus towards the windscreen, can be translucent such that the image halves can be presented on the partial surfaces of the projection surface.

A further aspect of the invention according to the examples relates to a motor vehicle with a head-up display according to the preceding aspect or an advantageous development thereof, wherein the head-up display is arranged in the region of an instrument panel of the motor vehicle.

Accordingly, the previously described head-up display can be used in the just described motor vehicle.

In an example, the head-up display is arranged in the region of an instrument panel or a dashboard of the motor vehicle. Thereby, a user of the motor vehicle sitting adjacent to the instrument panel, for example the driver of the motor vehicle, can very simply perceive images projected by the head-up display into the user's field of view if the user, in particular the driver, looks through the windscreen or windshield of the motor vehicle into the environment of the motor vehicle.

A further aspect of the invention according to the examples relates to a method for operating a head-up display, wherein a first image half of an image and a second image half of the image are provided by an image-generating unit, wherein the first image half of the image is based on light with a first polarization and the second image half of the image is based on light with a second polarization different from the first polarization, the first image half of the image is projected by a first optical unit onto a first partial surface of a projection surface, wherein the first optical unit is formed transmissive for the second image half of the image, which is based on light with the second polarization, and reflective for the second image half of the image, which is based on light with the first polarization, and the second image half of the image is projected by a second optical unit onto a second partial surface of the projection surface, wherein the image is presented on the projection surface by the two projected image halves.

Thus, a head-up display can be operated, which can present an image in the field of view of an observer, which is composed of two image halves.

In particular, a head-up display according to any one of the preceding aspects or an advantageous development thereof can be implemented or operated with the method according to the examples.

In an example of the just described method, it can be provided that the first image half is projected onto the first partial surface and the second image half is projected onto the second partial surface synchronously with each other such that the two image halves constitute the image on the projection surface. By the synchronous or simultaneous projection or presentation of the two image halves on the projection surface, a holistic presentation of the image can be provided to the observers. Thus, a particularly good presentation of the image in the field of view can be offered to the driver and/or passenger.

In particular, a head-up display according to any one of the preceding aspects or an advantageous development thereof can be implemented or operated with the method according to the examples.

Advantageous examples of one aspect are to be regarded as advantageous examples of another aspect or of all of the other aspects of the invention.

In particular, the head-up display and the motor vehicle can comprise a control device to execute the method according to the examples.

For application cases or application situations, which can arise in the method and which are not explicitly described here, it can be provided that an error message and/or a request for inputting a user feedback are output and/or a default setting and/or a predetermined initial state are adjusted according to the method.

The control device for the motor vehicle also belongs to the examples of the invention. The control device can comprise a data processing device or a processor device, which is configured to perform a method according to the examples of the invention. Hereto, the processor device can comprise at least one microprocessor and/or at least one microcontroller and/or at least one FPGA (Field Programmable Gate Array) and/or at least one DSP (Digital Signal Processor). Furthermore, the processor device can comprise program code, which is configured, upon execution by the processor device, to perform the embodiment of the method according to the invention. The program code can be stored in a data memory of the processor device. A processor circuit of the processor device can e.g. be based on at least one circuit board and/or on at least one SoC (System on Chip).

Developments of the motor vehicle according to the examples of the invention and of the method according to the examples of the invention, which comprise features, as they have already been described in context of the developments of the head-up display according to the examples of invention, also belong to aspects of the invention. For this reason, the corresponding developments of the motor vehicle according to the examples of the invention and of the method according to the examples of the invention are not again described here.

The motor vehicle according to the examples of the invention may be configured as an automobile, in particular as a passenger car or truck, or as a passenger bus or motorcycle.

As a further solution, the examples of the invention also include a computer-readable storage medium including commands, which, upon execution by a computer or a computer cluster, cause it to execute the method according to the examples of the invention. The storage medium can e.g. be provided at least partially as a non-volatile data memory (e.g. as a flash memory and/or as an SSD—solid state drive) and/or at least partially as a volatile data memory (e.g. as a RAM—random access memory). However, the storage medium can for example also be operated as a so-called Appstore server in the Internet. By the computer or computer cluster, a processor circuit with at least one microprocessor can be provided. The commands can be provided as a binary code or assembler code and/or as a source code of a programming language (e.g. C).

The examples of the invention also include the combinations of the features of the described examples. Thus, the examples of the invention also include realizations, which each comprise a combination of the features of the described examples if the examples have not been described as mutually exclusive.

### BRIEF DESCRIPTION OF DRAWINGS

In the following, execution examples of the invention are described with reference to the single FIGURE (Fig.):

The FIGURE shows a schematic representation of a head-up display according to an example.

### DESCRIPTION

The execution examples explained in the following are examples of the invention. In the execution examples, the described components of the examples each represent individual features of examples of the invention to be considered independently of each other, which each also develop the examples of the invention independently of each other. Therefore, the disclosure also is to include combinations of the features of the examples different from the illustrated ones. Furthermore, the described examples can also be supplemented by further ones of the already described features of the examples of the invention.

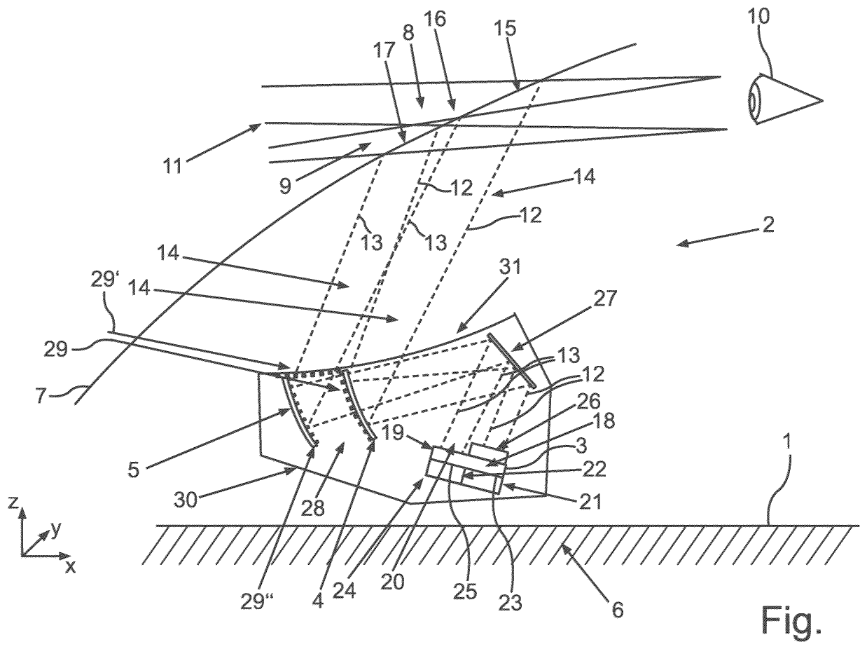

In the FIGURE, a motor vehicle 1 is shown in severely schematized manner, which comprises a head-up display 2. Furthermore, an image-generating unit 3 as well as a first and a second optical unit 4, 5 are illustrated in FIG. 1. They are shown in a schematic side view by way of example. Herein, the motor vehicle 1 is illustrated sectioned in a plane, which is parallel to a plane, which is spanned by the vehicle vertical axis Z and the vehicle longitudinal axis X.

The vehicle vertical axis Z, the vehicle longitudinal axis X as well as the vehicle transverse axis Y are illustrated by a coordinate system in FIG. 1. However, the orientations indicated by these axes are to be schematically construed with regard to the actual arrangement of the head-up display 2 in the motor vehicle 1 and only indicated for illustration.

The head-up display 2 can be arranged in the motor vehicle 1 in the region of an instrument panel 6, which is also reproduced only in severely schematized manner and not realistically with regard to its actual configuration and its dimensions in FIG. 1. In the direction of the vehicle vertical axis Z above the instrument panel 6 or on a dashboard, a windscreen 7 of the motor vehicle 1 is located, which is also only schematically and partially illustrated. For example, the windscreen 7 can be referred to as windshield.

In particular, the FIGURE shows a schematic arrangement for the head-up display 2, in which the head-up display 2 generates a virtual image.

The image-generating unit 3, which can be referred to as imager, can provide or generate a first image half 8 and a second image half 9. In particular, these two image halves 8, 9 can be presented in a field of view of an observer 10, in particular of a vehicle driver and/or passenger of the motor vehicle 1. Herein, the two image halves 8, 9 can be simultaneously or synchronously presented such that an, in particular virtual, image 11 can be presented for the observer 10 based on the two image halves 8, 9. Expressed in other words, the two image halves 8, 9 together constitute the image 11.

In order to be able to cause the image halves 8, 9 to be displayed in the region of the windscreen 7, the image-generating unit 3 can be configured such that the two image halves 8, 9 can be generated with each one different polarization type, polarization direction and/or polarization characteristic. Hereto, the image halves 8, 9 can be generated with light or a light beam respectively different in its polarization. For example, the first image half can be generated based on light with a first polarization 12 and the second image half can be generated based on light with a second polarization 13. For example, the light 12 can be S-polarized light. In contrast, the light 13 can be P-polarized light.

In the FIGURE, the light 12 and the light 13 are illustrated by lines (light beams). Furthermore, a beam path 14 from the image-generating unit 3 towards the windscreen 7 and from the windscreen 7 towards the observer 10 is schematically illustrated by lines.

The first optical unit 4 can for example be formed as an asphere or small asphere. In particular, the first optical unit 4 is configured such that it projects by reflection the first image half 8 onto a first partial surface 15 of an, in particular translucent, projection surface 16. The translucent projection surface 16 is in particular a preset or determined region of the windscreen 7. Herein, the translucent projection surface 16 can comprise the first partial region 15 and a second partial region 17. Thus, the two partial regions 15, 17 can constitute the projection surface 16. On the projection surface 16, the image 11 can be commonly constituted by the two image halves 8, 9. The first image half 8 can be reflected with the aid of the first optical unit 4 by reflection of the light 12 or light beams on the first optical unit 4. Furthermore, the first optical unit 4 is configured such that it is transmissive or transparent for the second image half 9, which is based on the light 13, whereby the second image half 9 can impinge on the second optical unit 5.

In particular, the image-generating unit 3 can be formed as a display.

The second optical unit 5 is in particular behind the first optical unit 4 viewed in the vehicle longitudinal axis X. In particular, the second optical unit 5 is arranged behind the first optical unit 4 in relation to the beam path 14. Thus, the first and the second optical unit 4, 5 can be arranged spaced from each other and immediately one behind the other.

As illustrated in the FIGURE, the two optical units 4, 5 have a distance to each other.

In an implementation, it is furthermore conceivable that at least one of the partial regions 15, 17 is formed as a black print display. A black print display (“BPD”) can be a region of the windscreen 7 in black print.

For providing or generating the two image halves 8, 9, the image-generating unit 3 can be bipartite or divided into two regions. Hereto, the image-generating unit 3 can comprise a first image-generating region 18 and a second image-generating region 19 separate or separated therefrom. The regions 18, 19 are in particular on an image-generating side 20 of the image-generating unit 3. The image-generating side 20 can be oriented towards the windscreen 7 viewed in vehicle vertical axis Z.

The first image-generating region 18 serves for generating or providing the first image half 8 based on the light 12. The second image-generating region 19 serves for providing or generating the second image half 9 based on the light 13. Thus, two image halves 8, 9 are generated here, which have a polarization different from each other.

Furthermore, the image-generating unit 3 can comprise two different illumination units 21, 22 for generating the different image halves 8, 9. The first illumination unit 21 can comprise a first region 23 of a rear side 24 of the image-generating unit 3 with light for providing the first image half 8. Furthermore, the second illumination unit 22 can supply a second partial region 25 different from the first partial region 23 with light for providing or generating the second image half 9. The first partial region 23 and the second partial region 25 are regions of the rear side 24 of the image-generating unit 3. The rear side 24 is in particular a side opposite to the image-generating side 20.

The illumination units 21, 22 can for example be formed as backlight systems.

As schematically visible in the FIGURE, the rear side 24 can be oriented to the instrument panel 6.

For example, the image-generating unit 3 can be formed such that it generates light with the second polarization. Hereto, a retardation plate 26 or a waveplate or “half wave plate” can be arranged in the first image-generating region 18. It is in particular arranged on the outermost side or surface of the image-generating side 20. The retardation plate 26 is formed such that it can convert light with the second polarization into light with the first polarization. Thus, the image-generating unit 3 can be even more simply configured.

The light beams or the lights 12, 13 radiated by the image-generating unit 3 can be reflected or directed from a first optical element 27 or a deflection mirror towards the first and second optical units 4, 5. According to configuration of the head-up display 2, the optical element 27 can be used, or according to arrangement, it can also be omitted.

The first optical unit 4, which is formed as a small asphere or freeform surface in the simplest case, can be composed of a glass, which has the characteristic to act reflective for light with the first polarization and transmissive for light with the second polarization. Now, if the light 12 impinges on the first optical unit 4, thus, it can be reflected towards the windscreen 7 and in particular towards the first partial surface 15 of the projection surface 16. The first image half 8 of the virtual image 11 is in turn presented for the observer 9 on the partial surface 15 or appears there for the observer 9.

In particular, the first image half 8 can be referred to as upper image half of the image 11 viewed in vehicle vertical axis Z. In contrast, the second image half 9 can be referred to as lower image half of the image 11.

In particular, the two optical units 4, 5 can be optically configured such that an enlarged, distant virtual image 11 with an eye box, which can in particular be configured for the driver and passenger of the motor vehicle 1 arises on the projection surface 16. Hereto, the image halves 8, 9 are simultaneously projected onto the projection surface 16 with the aid of the two optical units 4, 5.

The light beam 13, which is transmissive by the optical unit 4, can be reflected on the second optical unit 5 arranged behind the optical unit 4. Thus, the light 13 first passes through the optical unit 4 in relation to the beam path to be projected towards the second partial surface 17 on the second optical unit 5 arranged behind.

Thus, the second optical unit 5 is present behind the first optical unit 4 in the concerned beam path 14 from the image-generating unit 3 towards the observer 9.

In relation to the vehicle vertical axis Z, the second partial surface 17 can be arranged in a subjacent region of the windscreen 7 in relation to the projection surface 16. The two partial surfaces 15, 17 together span the projection surface 16. Thus, the partial surfaces 15, 17 can commonly or together constitute the projection surface 16.

For example, a further retardation plate 29 can be arranged in a region 28 between the first and the second optical unit 4, 5. Herein, there are different attaching or fixing positions. In FIG. 1, three possibilities of arrangement for the further retardation plate 29 are illustrated. For example, the retardation plate 29 can be arranged immediately on a rear side of the first optical unit 4. A further possibility is in the arrangement of the retardation plate, here denoted by 29′, in an outlet region of the light beams 12, 13 from the optical units 4, 5 towards the windscreen 7. A further arrangement of the retardation plate is illustrated by the reference character 29″. Herein, the retardation plate 29″ can be arranged directly on the front side, thus to the side, which is directed to the optical unit 4. Further possibilities are also conceivable.

In particular, the further retardation plate 29 is formed to change the light 13, which has passed through the optical unit 4, in its polarization such that the light relating to the first and the second image half 8, 9 has the same polarization. In this case, the lights or light beams respectively reflected from the optical units 4, 5 towards the windscreen 7 can be equal in polarization. In this case, the image halves would be radiated or emitted from the optical unit 4, 5 with a light with the first polarization.

This is of importance for a good image presentation of the entire image 11 such that a common image 11 can be constituted of the two image halves 8, 9.

For example, the head-up display 2 can comprise a housing 30. For example, the image-generating unit 3, the optical units 4, 5, the optical element 27 and thus some of the previously mentioned components of the head-up display 2 can be arranged in the housing 30. In particular, all of the components of the head-up display 2 can be arranged in the housing 30. All of the components, which are especially sensitive optical elements, can be protected from dust, dirt and water by the housing 30. In order to be able to project the image halves 8, 9 onto the windscreen 7, the housing 30 comprises a housing part 31 translucent towards the projection surface 16. In particular, the housing part 31 is the region of the housing 30, which is directed upwards to the windscreen 7 in vehicle vertical axis Z. The housing part 31 can for example be formed as a transparent display, “glare trap” and/or “cover glass”.

In the following, the head-up display 2 according to the examples of the invention is explained in other words.

The head-up display 2 can especially be divided into two optical paths and thus compose the virtual image 11 of two parts, thus the image halves 8, 9. Here, the two optical paths can be used for the lights 12, 13.

The imager or the image-generating unit 3 can be a display, which is divided into two regions, thus the regions 18, 19, and comprises two different backlight systems or illumination units 21, 22. The first illumination unit 21 can be configured for the upper part of the virtual image, thus for the first image half 8. The second illumination unit 22 can be configured for the lower part of the virtual image, thus for the second image half 9. The imager 3 for example emits P-polarized light, which can for example be the light 13 with the second polarization. By a “half wave plate” (retardation plate 26) arranged in the region of the imager, which emits light for the upper part of the virtual image, S-polarized light, thus the light 12, arises from the P-polarized light. Of course, the same also applies to an imager with S-polarized light, wherein all of the further polarizations are correspondingly reversed.

The first optical unit 4 or a first asphere is for example composed of a glass and has the characteristic to act reflective for S-polarized light and transmissive for P-polarized light. Now, if the S-polarized portion of the light impinges on the first asphere, thus, it is directly reflected towards the windscreen 7 to then travel on the screen towards the observer 10 and to cause the upper virtual image to appear. Due to the optical configuration of the mirror or the first optical unit 4, an enlarged, distant virtual image 11 with an eye box arises, which can be only for the driver. The P-polarized light, thus the light 13, passes through the first asphere. In order to achieve a uniform appearance of the two virtual images 8, 9, with respect to the brightness, the P-polarized light can be rotated by 90 degrees in the polarization after transit or passage through the first asphere within the head-up display 2. Thereto, a further “half wave plate” (further retardation plate 29) can be attached at various locations. For example, it can be attached directly on the rear side of the first asphere or within the two aspheres or housing part 31. Furthermore, it is conceivable to apply a “quarter wave plate 29” to the front side of the second asphere or the second optical unit 5 for rotating the light. The light is reflected on a region of the windscreen 7 located slightly deeper via the second asphere located behind and constitutes the lower part of the virtual image.

The optical configuration is effected such that the lower part and the upper part of the virtual image 11 are close to each other and thus an overall larger region can be covered with the virtual image 11.

Overall, the examples show how a head-up display with two aspheres and a combined display region can be provided.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1.-10. (canceled)

11. A head-up display for a motor vehicle, comprising:
an image-generating unit to provide a first image half of an image and a second image half of the image, such that the first image half of the image is based on a first light with a first polarization and the second image half of the image is based on a second light with a second polarization different from the first polarization,
a first optical unit to project by reflection the first image half of the image onto a first partial surface of a projection surface, the first optical unit is transmissive for the second image half of the image, which is based on the second light with the second polarization, and reflective for the first image half of the image, which is based on first light with the first polarization,
a second optical unit to project by reflection the second image half of the image onto a second partial surface of the projection surface, the second optical unit is arranged immediately behind the first optical unit in relation to a beam path of the first image half and the second image half of the image.

12. The head-up display according to claim 11, comprising:
a first illumination unit to supply a first region of a rear side of the image-generating unit with light to provide the first image half of the image, and
a second illumination unit different from the first illumination unit to supply a second region of the rear side of the image-generating unit different from the first region with light to provide the second image half of the image.

13. The head-up display according to claim 11, wherein
the image-generating unit comprises an image-generating side including a first image-generating region to provide the first image half of the image and a second image-generating region different from the first image-generating region to provide the second image half of the image.

14. The head-up display according to claim 13, wherein
a first retardation plate is arranged at the first image-generating region, such that the first retardation plate is configured to convert light, which is radiated from the first image-generating region, into the first light with the first polarization, on which the first image half is based.

15. The head-up display according to claim 14, wherein
a second retardation plate is arranged in a region between the first optical unit and the second optical unit, such that the second retardation plate is configured to change the second polarization of the second light, on which the second image half is based, so that the first light relating to the first image half and the second light relating to the second image half have a same polarization.

16. The head-up display according to claim 11, comprising:
a first optical element to reflect the first image half and the second image half of the image towards the first optical unit and the second optical unit.

17. The head-up display according to claim 11, wherein the image-generating unit, the first optical unit and the second optical unit are arranged in a housing closed towards an environment of the head-up display, wherein the housing comprises a housing part translucent towards the projection surface so that first image half and the second image half are projectable through the housing part onto the projection surface.

18. A motor vehicle with the head-up display according to claim 11, wherein the head-up display is arranged in a region of an instrument panel of the motor vehicle.

19. A method of operating a head-up display, comprising:
executing, by a control device configured with a processor, a process to
control an image generating unit to provide a first image half of an image and a second image half of the image, the first image half of the image being based on a first light with a first polarization and the second image half of the image being based on a second light with a second polarization different from the first polarization, such that
a first optical unit projects the first image half of the image onto a first partial surface of a projection surface, the first optical unit being transmissive for the second image half of the image, which is based on the second light with the second polarization, and reflective for the first image half of the image, which is based on first light with the first polarization, and
a second optical unit projects the second image half of the image onto a second partial surface of the projection surface, so that the image is projected on the projection surface based on the first image half and the second image half.

20. The method according to claim 19, wherein the first image half is projected onto a first partial surface of the projection surface and the second image half is projected onto a second partial surface of the projection surface synchronously with each other such that the first image half and the second image half constitute the image on the projection surface.
